(19) United States
(12) Patent Application Publication
(10) Pub. No.: US 2022/0374383 A1
(43) Pub. Date: Nov. 24, 2022

(54) TRANSACTION MAPPING MODULE

(71) Applicant: Nordic Semiconductor ASA, Trondheim (NO)

(72) Inventor: Berend Dekens, Trondheim (NO)

(73) Assignee: Nordic Semiconductor ASA, Trondheim (NO)

(21) Appl. No.: 17/750,135

(22) Filed: May 20, 2022

(30) Foreign Application Priority Data
May 24, 2021 (GB) 2107390.3

(51) Int. Cl. G06F 13/42; G06F 9/46

(52) U.S. Cl. CPC G06F 13/42; G06F 9/466

(57) ABSTRACT

An electronic device comprises a module configured to transfer data bus transactions from a transaction source domain to a transaction target domain. A first interface receives the transaction from the source domain using a transaction source ID. A second interface sends the transaction to the target domain using a transaction target ID. A look-up table has a plurality of index values and stores the transaction source ID against one of the index values. Mapping logic determines whether the look-up table contains the transaction source ID stored against any of the index values. When the transaction source ID is already stored, the transaction target ID is set to that index value. Conversely, when the transaction source ID is not stored, an available index value is selected, the transaction source ID is stored against that available index value, and the transaction target ID is set to that available index value.

### CROSS-REFERENCE TO RELATED APPLICATION

This application claims priority from United Kingdom Patent Application No. 2107390.3, filed May 24, 2021, which application is incorporated herein by reference in its entirety.

### TECHNICAL FIELD

The present invention relates to a module for mapping transactions between different transaction domains in a data bus, particularly but not exclusively for AXI data buses.

### BACKGROUND

Many modern electronic devices include a number of buses to allow different on-chip devices to communicate with one another. Generally, these buses connect at least one ‘master’ device to at least one ‘slave’ device, and allows the master to issue commands to and/or exchange data with the slave.

One bus that is commonly used for on-chip communication is the Advanced eXtensible Interface (AXI) bus, defined within the ARM® Advanced Microcontroller Bus Architecture specifications, e.g. the ‘AXI3’, ‘AXI4’, and ‘AXI5’ specifications. This packet-switched bus provides a high performance multi-master to multi-slave communication interface.

The AXI specification outlines five channels for transactions, these are: the Read Address channel (AR); the Read Data channel (R); the Write Address channel (AW); the Write Data channel (W); and the Write Response channel (B).

Large multi-layer buses like AXI-based buses use transaction IDs (TIDs) to uniquely identify requests and responses. The AXI protocol specification explains how an interconnect should add bits to existing TIDs originating from bus masters to prevent collisions in TID values between multiple masters on the same bus which would otherwise make it impossible for responses to be returned to the correct master. In essence, this means a transaction ID becomes wider as it traverses the interconnect layer by layer. For example, a transaction generated by a master may have an initial 4-bit TID that, after traversing several interconnect layers, may end up being a 16-bit TID, thus requiring a lot more registers to store, and making the logic for managing the TIDs significantly largely.

When two interconnects are able to access each other's slaves, this scheme breaks and needs a workaround as neither interconnect is ‘below’ the other.

Additionally, the TID widths must be sufficiently wide to allow all master-to-slave paths to be uniquely identified, and to allow for any ‘looped’ interconnect layers to be resolved, i.e. the entire bus architecture must be fully defined. In other words, all masters, slaves and their interconnection patterns need to be specified to generate a solution for TID widths per master, per slave, per bus component and per interconnect. This solution may, in general, be determined using a suitable tool.

The Applicant has appreciated that it would be advantageous to avoid these issues.

### SUMMARY

When viewed from a first aspect, embodiments of the present invention provide an electronic device comprising a module configured to transfer data bus transactions from a transaction source domain to a transaction target domain, the module comprising:
a first interface configured to receive a transaction from the transaction source domain, said transaction having a transaction source ID associated therewith;
a second interface configured to send the transaction to the transaction target domain, said transaction having a transaction target ID associated therewith;
a look-up table having a plurality of index values, said look-up table being configured to store the transaction source ID against one of said plurality of index values; and
a mapping logic configured such that when a transaction is received via the first interface, the mapping logic determines whether the look-up table contains the transaction source ID stored against any of the plurality of index values in said look-up table;
said mapping logic being further configured such that:
   when the transaction source ID is already stored against an index value in the look-up table, the transaction target ID is set to the index value that said transaction source ID is stored against in the look-up table; and
   when the transaction source ID is not stored against any of the index values in the look-up table, an available index value is selected and the transaction source ID is stored against said available index value in the look-up table, and the transaction target ID is set to said available index value.

The first aspect of the invention extends to a method of transferring data bus transactions from a transaction source domain to a transaction target domain, the method comprising:
receiving a transaction from the transaction source domain, said transaction having a transaction source ID associated therewith;
storing the transaction source ID against one of a plurality of index values in a look-up table; and
when a transaction is received from the transaction source domain, determining whether the look-up table contains the transaction source ID stored against any of the plurality of index values in said look-up table;
when the transaction source ID is already stored against an index value in the look-up table, setting a transaction target ID to the index value that said transaction source ID is stored against in the look-up table; and
when the transaction source ID is not stored against any of the index values in the look-up table, selecting an available index value, storing the transaction source ID against said available index value in the look-up table, and setting the transaction target ID to said available index value; and
sending the transaction to the transaction target domain using the transaction target ID.

The first aspect of the present invention further extends to a non-transitory computer-readable medium comprising instructions that, when executed by a processor, cause the processor to carry out a method of transferring data bus transactions from a transaction source domain to a transaction target domain, the method comprising:
receiving a transaction from the transaction source domain, said transaction having a transaction source ID associated therewith;
storing the transaction source ID against one of a plurality of index values in a look-up table; and
when a transaction is received from the transaction source domain, determining whether the look-up table contains the transaction source ID stored against any of the plurality of index values in said look-up table;
when the transaction source ID is already stored against an index value in the look-up table, setting a transaction target ID to the index value that said transaction source ID is stored against in the look-up table; and
when the transaction source ID is not stored against any of the index values in the look-up table, selecting an available index value, storing the transaction source ID against said available index value in the look-up table, and setting the transaction target ID to said available index value; and
sending the transaction to the transaction target domain using the transaction target ID.

The first aspect of the present invention also extends to a computer software product comprising instructions that, when executed by a processor, cause the processor to carry out a method of transferring data bus transactions from a transaction source domain to a transaction target domain, the method comprising:
receiving a transaction from the transaction source domain, said transaction having a transaction source ID associated therewith;
storing the transaction source ID against one of a plurality of index values in a look-up table; and
when a transaction is received from the transaction source domain, determining whether the look-up table contains the transaction source ID stored against any of the plurality of index values in said look-up table;
when the transaction source ID is already stored against an index value in the look-up table, setting a transaction target ID to the index value that said transaction source ID is stored against in the look-up table; and
when the transaction source ID is not stored against any of the index values in the look-up table, selecting an available index value, storing the transaction source ID against said available index value in the look-up table, and setting the transaction target ID to said available index value; and
sending the transaction to the transaction target domain using the transaction target ID.

Thus it will be appreciated that embodiments of the present invention provide a mechanism for bridging transactions between the different transaction domains, which may then each have their own ID ranges and bus widths. Embodiments of the present invention provide for both mapping of the transaction ID between the domains as well as providing flow control.

Those skilled in the art will appreciate that the present invention provides transaction ID mapping that translates the transaction ID from the transaction source domain—or ‘domain A’—ID (IDₐ) to the transaction target destination domain—or ‘domain B’—ID (ID_{b}) for the address channel. When a new transaction is initiated from the source domain A, a lookup is performed in the look-up table (M_{id}), i.e. an internal bookkeeping table, to see if a transaction with the same IDₐ is already active. If so (i.e. if a transaction with the same IDₐ is active, as indicated by IDₐ being present in M_{id}), the mapped ID_{b} will be the index in M_{id} where IDₐ is located. Conversely, if the transaction with the same IDₐ is not active, ID_{b} is set equal to a free index of M_{id} (i.e. that does not store the ID of any active transaction). Generally, the first free index of M_{id} may be used, though this is not a strict requirement and any free (i.e. ‘available’) index could be selected.

In other words, the bus is effectively partitioned into different domains (i.e. sections), where each domain may have its own transaction ID widths as required, and where the remapping module is placed between the partitions to remap transaction IDs as necessary. This remapping maps numeric values to other numeric values, but with the capability of mapping wide IDs to narrow IDs (and vice versa).

This solution solves the problem with looped interconnects and also removes the need to fully define the entire bus interconnect before being able to compute the required number of transaction ID bits that are needed to connect all components correctly. The resulting bus interconnect may use an absolute minimum number of transaction ID bits, thereby reducing the amount of hardware needed.

This is achieved by way of a trade-off, in that the number of concurrent transaction IDs that can be used is limited by the size of the look-up table, i.e. the number of index values that are available for assigning transaction IDs from the source domain. Those skilled in the art may readily evaluate the look-up table size vs concurrency trade-off and determine a suitable look-up table size to allow an acceptable degree of concurrent accesses from one or more masters in the source domain to one or more slaves in the target domain. The limits of the number of unique transaction IDs and the number of active transactions with an identical transaction ID are both parameterisable.

It will be appreciated that mappings may also be carried out in the reverse direction, i.e. from ID_{b} to IDₐ—e.g. for a response channel (i.e. transactions flowing from B to A) which may be either a transfer on the read data channel or the write response channel. When mapping from the second transaction domain B to the first transaction domain A, it is assumed that all active transactions (i.e. all transactions that can give a response on the response channel), are registered in the look-up table. When a transfer for a transaction arrives on the return channel, IDₐ is the ID stored on index ID_{b} in the look-up table M_{id}. Thus, in some embodiments, the mapping logic is further configured such that when a transaction is received via the second interface, the mapping logic determines the transaction source ID stored in the look-up table against the index value equal to the transaction target ID, and sends the transaction to the transaction source domain using the determined transaction source ID.

It will be appreciated that the principles of the present invention may apply to a number of different data buses, known in the art per se. However, in some embodiments, the data bus is an AXI bus or an AXI Lite bus.

The module outlined hereinabove may handle read transactions and/or write transactions, as appropriate. Where both read and write transactions are to be handled, separate modules may be provided for each of these types of transactions.

In other words, the module outlined hereinabove may be arranged to handle write transactions or read transactions. In a particular set of embodiments, the data bus transactions transferred by the first module comprise data bus write transactions or data bus read transactions. In some such embodiments where the first module handles data bus write transactions, the device further comprises a second module configured to transfer data bus read transactions from the transaction source domain to the transaction target domain, the second module comprising:
a third interface configured to receive a read transaction from the transaction source domain, said read transaction having a transaction source ID associated therewith;
a fourth interface configured to send the read transaction to the transaction target domain, said read transaction having a transaction target ID associated therewith;
a second look-up table having a plurality of index values, said second look-up table being configured to store the transaction source ID of the read transaction against one of said plurality of index values; and
a second mapping logic configured such that when a read transaction is received via the third interface, the second mapping logic determines whether the second look-up table contains the transaction source ID of the read transaction stored against any of the plurality of index values in said second look-up table;
said second mapping logic being further configured such that:
   when the transaction source ID of the read transaction is already stored against an index value in the second look-up table, the transaction target ID is set to the index value that said transaction source ID of the read transaction is stored against in the second look-up table; and
   when the transaction source ID of the read transaction is not stored against any of the index values in the second look-up table, an available index value is selected and the transaction source ID of the read transaction is stored against said available index value in the look-up table, and the transaction target ID is set to said available index value.

In some embodiments, the look-up table further comprises a counter value for each index value, wherein:
when a new transaction is received having a transaction source ID that is already stored against an index value in the look-up table, the counter value associated with said index value is incremented; and
when a transaction is completed, the associated counter value is decremented.

In some embodiments, entries in the look-up table may be cleared when the associated counter value reaches zero, i.e. when there are no outstanding transactions having that transaction ID. However this is not necessary, as those entries having a counter value of zero may instead just be treated as being empty, without the additional step of actually clearing it from the look-up table.

It should also be noted that while in some embodiments the counter being zero to indicate that the associated index in the look-up table is free, alternative approaches may be taken. For example, the look-up table may comprise a dedicated ‘active’ (or ‘in use’) field—a flag or binary value which can be enabled or disabled—which can be set and inspected. Thus this field could be set high when the counter is non-zero to indicate that the index is in use. Alternatively, the counter value could be left at one when setting this active field to low such that the rest of the row in the look-up table is not updated at all and the active field is toggled to mark that index of the look-up table as free or not.

When a transaction having a particular transaction ID is started and completed in the same cycle, the counter may be incremented and decremented in the same cycle. If both the forward and reverse channels carry the same transaction ID which has been issued multiple times, the counter value would be non-zero and during the same cycle would be incremented (due to the forward channel) and decremented (due to the reverse channel) so at the end of the cycle, the counter value would be the same as it was at the start of that cycle.

The optional features outlined hereinabove in respect of various embodiments of the present invention may be combined in any suitable combination and/or permutation as appropriate. It will be appreciated that the optional features described above in respect of a particular module that handles the transfers from one transaction domain to another also apply to a second such module, where provided (i.e. in embodiments where separate modules are provided for read and write transactions). The two modules may be functionally identical or may be different from one another, as appropriate.

### BRIEF DESCRIPTION OF DRAWINGS

Certain embodiments of the invention will now be described, by way of non-limiting example only, with reference to the accompanying drawings in which:

FIG. 1 is a block diagram illustrating a module in accordance with an embodiment of the present invention;

FIG. 2 is a diagram illustrating the structure of the look-up table used by the module of FIG. 1;

FIG. 3 is a schematic diagram illustrating a process of updating the look-up table of FIG. 2; and

FIG. 4 is a block diagram showing an electronic device having separate modules for read and write transactions.

### DETAILED DESCRIPTION

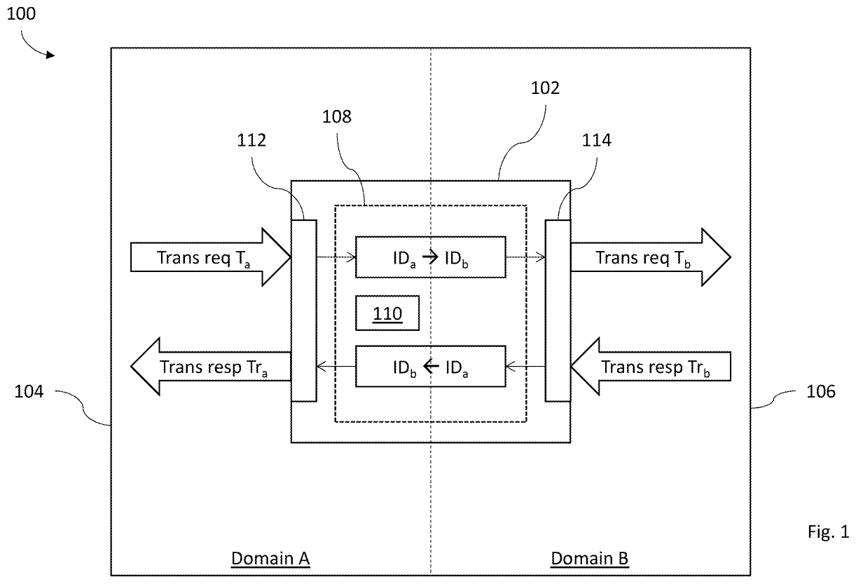

FIG. 1 is a block diagram illustrating an electronic device 100 comprising a module 102 in accordance with an embodiment of the present invention. The module 102 is arranged to translate transaction IDs on an AXI bus between a first transaction ID domain (referred to interchangeably as ‘domain A’) 104 and a second transaction ID domain (referred to interchangeably as ‘domain B’) 106.

The module 102 includes a mapping logic 108 and a look-up table (LUT) 110, which are outlined in further detail below. It will be appreciated that while FIG. 1 shows a particular arrangement, this is for illustrative purposes and for ease of reference, and the embodiments of the present invention may have different physical and/or logical configurations. For example, the look-up table 110 need not necessarily be a component within the mapping logic 108. The mapping logic 108 may be carried out by a single processor (or other processing means), or its function may be distributed across a number of different components.

The module is configured to receive an AXI transaction request Tₐ from domain A 104, which in this example is the AXI transaction source domain. This transaction request Tₐ is received via a first interface 112 of the module 102. The transaction request Tₐ will, in general, have a transaction ID, denoted ‘IDₐ’, where IDₐ has an associated transaction ID width dependent on the width specified by domain A 104.

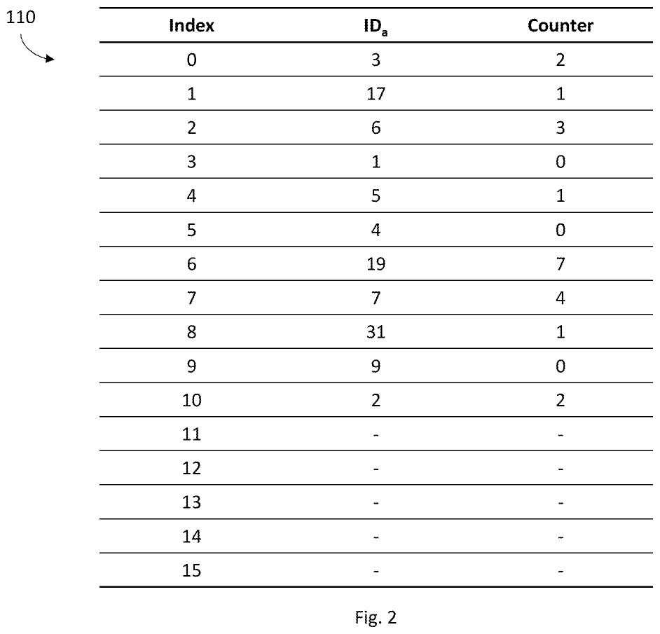

The mapping logic 108 uses the LUT 110 to translate transaction IDs between the two domains, i.e. from a transaction IDₐ in domain A 104 to a transaction ID_{b} in domain B 106, and vice versa. The structure of this LUT 110 can be seen in FIG. 2.

The LUT 110 has a number of columns: an index, the source domain transaction IDₐ, and a counter value, which are outlined in turn below.

The ‘Index’ column provides an identifier for each row in the LUT 110. In this particular example, the index values range from 0 to 15, i.e. they can be represented as a four-bit binary number ranging from 0b0000 (decimal ‘0’) to 0b1111 (decimal ‘15’). As outlined in further detail below, these correspond to the transaction ID_{b} supplied with the transaction request to the second transaction domain B 106, which in this example is configured to use a four-bit transaction ID width. The number of index values available limits the concurrency of the system, i.e. how many unique transactions can be handled simultaneously. Those skilled in the art may make a suitable determination as to how much concurrency is required, and size the LUT 110 accordingly.

The ‘IDₐ’ column stores a source transaction domain IDₐ against one of these index values. In this case, the source domain A 104 may assign transaction ID values b between 0 and 31, i.e. they can be represented as a five-bit binary number ranging from 0b00000 (decimal ‘0’) to 0b11111 (decimal ‘31’). It will of course be appreciated that different transaction ID widths for each of the domains may be used, and either domain A 104 or domain B 106 may have a wider transaction ID width than the other (or they may be the same, albeit with a reduced benefit from the transaction ID width conversion afforded by the present invention).

The ‘Counter’ column stores the total number of pending transactions having a given IDₐ. A value of ‘0’ in this column indicates that there are no active transactions having that IDₐ and thus that row (i.e. that index) may be overwritten, but it hasn't been cleared from memory. It will be appreciated that certain logic may, alternatively, act to remove entries from the LUT 110 when their associated counter value reaches zero.

It should also be noted that the counter being ‘0’ to indicate a ‘free’ row is a choice, and alternative approaches may be taken. For example, the LUT 110 could instead include a dedicated ‘active’ or ‘in use’ field which can be set and inspected (where this field would be set high when the counter is non-zero in this case) rather than looking at the counter value. Alternatively, the counter value could be left at one when setting active/used to low such that the rest of the row in the LUT 110 is not updated at all and the active field is toggled to mark that index of the LUT 110 as free or not.

It can be seen in the ‘snapshot’ of FIG. 2 that the first eleven of the index values have been used at some point, where index values 0, 1, 2, 4, 6, 7, 8, and 10 all have active transactions associated with them (i.e. they have non-zero counter values for a given IDₐ). Index values 3, 5, and 9 have been used for transactions previously, but now have a counter value of zero and are now available for re-use. Counter values 11, 12, 13, 14, and 15 have not yet been used, indicated by the ‘-’ in the respective cells of the table.

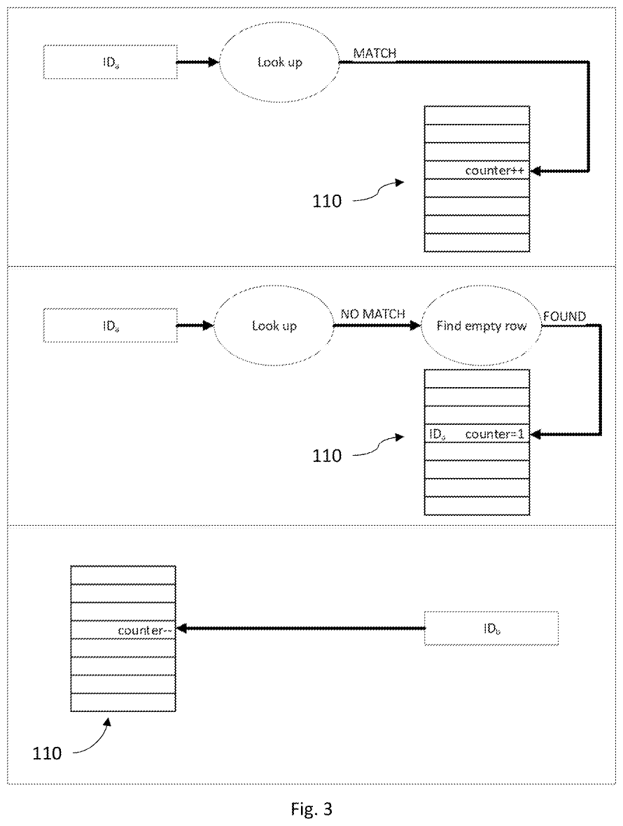

As illustrated in FIG. 3, when a transaction request Tₐ is received, the mapping logic 108 checks the LUT 110 to see whether there are already any active transactions having that same source domain transaction IDₐ in the LUT 110, i.e. an index value against which that same IDₐ is stored, where the counter value is greater than zero. If there is a match, the counter value associated with that index value is incremented (counter++), corresponding to the new number of pending transaction(s) for that IDₐ value. The index value associated with the match is then used as the target domain ID_{b} when the transaction is supplied to domain B 106 as T_{b} via a second interface 114.

By way of an example with reference to FIG. 2, a new transaction request Tₐ with IDₐ=19 would find a match in index value 6, and so the counter would be updated from 7 to 8, and the transaction would then be supplied to domain B 106 as T_{b} having ID_{b}=6 (i.e. the index value).

If, on the other hand, a transaction request Tₐ is received having an IDₐ that isn't currently active, i.e. for which there is no match in the LUT 110, the mapping logic 108 selects an available index and stores the IDₐ against it, setting the counter value for that index to one (counter=1). That index value is then used as ID_{b} when the AXI transaction is passed to domain B 106 as T_{b}.

Referring again to FIG. 2, a new transaction request Tₐ is received with IDₐ=8, which is not currently stored in the LUT 110. The mapping logic 108 may select an available index value (i.e. one having a counter value of zero ‘0’ or empty ‘-’) and store the IDₐ of Tₐ against it. For example, index value 3 may be used, overwriting the old entry of IDₐ=1; or index value 11 could be used for the first time. The counter value associated with the selected index value is incremented, and the index value is then used as ID_{b} for T_{b}.

When a transaction response Tr_{b} is received from domain B 106, the mapping logic 108 carries out a reverse translation by checking the index value equal to the ID_{b} associated with the response Tr_{b} in the LUT 110, and the transaction response is passed to domain A as Trₐ using the IDₐ stored against that index value (i.e. the index value equal to ID_{b}).

When a transaction is resolved, i.e. when it completes, the LUT 110 is updated to decrement the counter value for the associated index (counter--). For example, if the transaction having IDₐ=5 completes before any new transaction request having that same IDₐ value is received, the counter value for index value 4 is decremented from ‘1’ to ‘0’, thus rendering index value 4 available for use.

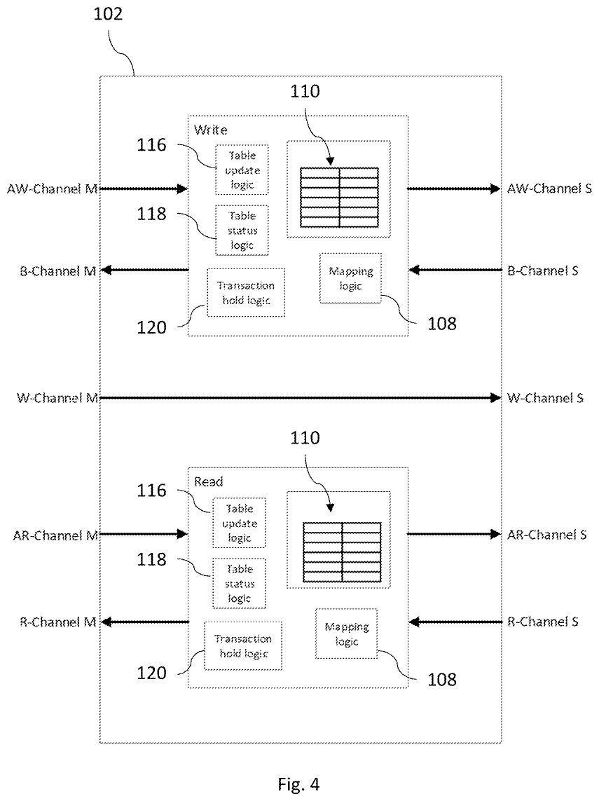

FIG. 4 is a block diagram showing an electronic device having separate modules for read and write transactions. As can be seen in FIG. 4, the various AXI channels AW, W, B, AR, R are appended with an ‘M’ for the master-side of the channel, and with an ‘S’ for the slave-side of the channel.

It will be appreciated that the transaction requests Tₐ, T_{b} and responses Trₐ, Tr_{b} outlined above may correspond to read transactions, e.g. where a master device in domain A 104 wishes to read something from the memory of a slave device in domain B 106. In such a scenario, the transaction request Tₐ, T_{b} may be for a read operation of a particular memory location using the ‘Read Address’ (AR) channel of the AXI bus; and the response Trₐ, Tr_{b} may be the associated data from that memory location on the ‘Read’ (R) channel of the AXI bus.

Alternatively, the transaction requests Tₐ, T_{b} and responses Trₐ, Tr_{b} outlined above may correspond to write transactions, e.g. where a master device in domain A 104 wishes to write something to the memory of a slave device in domain B 106. In such a scenario, the transaction request Tₐ, T_{b} may be for a write operation of a particular memory location using the ‘Write Address’ (AW) channel of the AXI bus. Those skilled in the art will appreciate that the actual data to be written is generally supplied separately over the ‘Write Data’ (W) channel of the AXI bus. The response Trₐ, Tr_{b} may be an acknowledgement of the write operation on the ‘Write Response’ (B) channel of the AXI bus. It will be appreciated that the forward and reverse channels may differ, depending on the particular bus protocol in use, e.g. if using the AXI3 protocol, the W channel also carries the transaction IDs.

For ease of illustration, the table update logic 116 which handles updates to the LUT 110; the table status logic 118 which checks the entries in the LUT 110; and the transaction hold logic 120 which handles transaction holds, are shown separately to the mapping logic 108. Each of these functions may be carried out by separate logic modules, or one or more of these functions may be carried out within a combined module. For example, all of these functions map be carried out within the mapping logic 108.

Thus it will be appreciated that embodiments of the present invention provide an improved arrangement in which a ‘mapper’ module translates transaction IDs between different domains, allowing for different transaction ID widths to be used between these domains. This arrangement may avoid the need to ‘grow’ a transaction ID at each interconnect level to keep track of where they come from, instead allocating one of a set of internal references (the index value) to a particular source transaction ID, and using that for all corresponding transactions having that same ID until it is no longer active. This arrangement may allow for complex loops to be handled more easily, and on an ad hoc basis, i.e. without needing to map out all master-slave paths in advance, by trading off against the maximum transaction concurrency of the system.

While specific embodiments of the present invention have been described in detail, it will be appreciated by those skilled in the art that the embodiments described in detail are not limiting on the scope of the claimed invention.

1. An electronic device comprising a module configured to transfer data bus transactions from a transaction source domain to a transaction target domain, the module comprising:
a first interface configured to receive a transaction from the transaction source domain, said transaction having a transaction source ID associated therewith;
a second interface configured to send the transaction to the transaction target domain, said transaction having a transaction target ID associated therewith;
a look-up table having a plurality of index values, said look-up table being configured to store the transaction source ID against one of said plurality of index values; and
a mapping logic configured such that when a transaction is received via the first interface, the mapping logic determines whether the look-up table contains the transaction source ID stored against any of the plurality of index values in said look-up table;
said mapping logic being further configured such that:
when the transaction source ID is already stored against an index value in the look-up table, the transaction target ID is set to the index value that said transaction source ID is stored against in the look-up table; and
when the transaction source ID is not stored against any of the index values in the look-up table, an available index value is selected and the transaction source ID is stored against said available index value in the look-up table, and the transaction target ID is set to said available index value.

2. The electronic device of claim 1, wherein the data bus is an AXI bus or an AXI Lite bus.

3. The electronic device of claim 1, wherein the mapping logic is further configured such that when a transaction is received via the second interface, the mapping logic determines the transaction source ID stored in the look-up table against the index value equal to the transaction target ID, and sends the transaction to the transaction source domain using the determined transaction source ID.

4. The electronic device of claim 1, wherein the data bus transactions transferred by the first module comprise data bus read transactions.

5. The electronic device of claim 1, wherein the data bus transactions transferred by the first module comprise data bus write transactions.

6. The electronic device of claim 5, further comprising a second module configured to transfer data bus read transactions from the transaction source domain to the transaction target domain, the second module comprising:
a third interface configured to receive a read transaction from the transaction source domain, said read transaction having a transaction source ID associated therewith;
a fourth interface configured to send the read transaction to the transaction target domain, said read transaction having a transaction target ID associated therewith;
a second look-up table having a plurality of index values, said second look-up table being configured to store the transaction source ID of the read transaction against one of said plurality of index values; and
a second mapping logic configured such that when a read transaction is received via the third interface, the second mapping logic determines whether the second look-up table contains the transaction source ID of the read transaction stored against any of the plurality of index values in said second look-up table;
said second mapping logic being further configured such that:
when the transaction source ID of the read transaction is already stored against an index value in the second look-up table, the transaction target ID is set to the index value that said transaction source ID of the read transaction is stored against in the second look-up table; and
when the transaction source ID of the read transaction is not stored against any of the index values in the second look-up table, an available index value is selected and the transaction source ID of the read transaction is stored against said available index value in the look-up table, and the transaction target ID is set to said available index value.

7. The electronic device of claim 1, wherein the look-up table further comprises a counter value for each index value, wherein:
when a new transaction is received having a transaction source ID that is already stored against an index value in the look-up table, the counter value associated with said index value is incremented; and
when a transaction is completed, the associated counter value is decremented.

8. A method of transferring data bus transactions from a transaction source domain to a transaction target domain, the method comprising:
receiving a transaction from the transaction source domain, said transaction having a transaction source ID associated therewith;
storing the transaction source ID against one of a plurality of index values in a look-up table; and
when a transaction is received from the transaction source domain, determining whether the look-up table contains the transaction source ID stored against any of the plurality of index values in said look-up table;
when the transaction source ID is already stored against an index value in the look-up table, setting a transaction target ID to the index value that said transaction source ID is stored against in the look-up table; and
when the transaction source ID is not stored against any of the index values in the look-up table, selecting an available index value, storing the transaction source ID against said available index value in the look-up table, and setting the transaction target ID to said available index value; and
sending the transaction to the transaction target domain using the transaction target ID.

9. The method of claim 8, wherein the data bus is an AXI bus or an AXI Lite bus.

10. The method of claim 8, further comprising:
when a transaction is received from the transaction target domain, determining the transaction source ID stored in the look-up table against the index value equal to the transaction target ID; and
sending the transaction to the transaction source domain using the determined transaction source ID.

11. The method of claim 8, wherein the data bus transactions transferred by the first module comprise data bus read transactions.

12. The method of claim 8, wherein the data bus transactions transferred by the first module comprise data bus write transactions.

13. The method of claim 12, further comprising transferring data bus read transactions from the transaction source domain to the transaction target domain, the method further comprising:
receiving a read transaction from the transaction source domain, said read transaction having a transaction source ID associated therewith;
storing the transaction source ID of the read transaction against one of a plurality of index values in a second look-up table; and
when a read transaction is received from the transaction source domain, determining whether the second look-up table contains the transaction source ID of the read transaction stored against any of the plurality of index values in said second look-up table;
when the transaction source ID of the read transaction is already stored against an index value in the second look-up table, setting a transaction target ID to the index value that said transaction source ID of the read transaction is stored against in the second look-up table; and
when the transaction source ID of the read transaction is not stored against any of the index values in the second look-up table, selecting an available index value, storing the transaction source ID of the read transaction against said available index value in the second look-up table, and setting the transaction target ID to said available index value; and
sending the read transaction to the transaction target domain using the transaction target ID.

14. The method of claim 8, wherein the look-up table further comprises a counter value for each index value, the method further comprising:
when a new transaction is received having a transaction source ID that is already stored against an index value in the look-up table, incrementing the counter value associated with said index value; and
when a transaction is completed, decrementing the associated counter value.

15. A non-transitory computer-readable medium comprising instructions that, when executed by a processor, cause the processor to carry out the method of claim 8.
